(19) United States
(12) Patent Application Publication
(10) Pub. No.: US 2018/0053309 A1
(43) Pub. Date: Feb. 22, 2018

(54) Spatial Alignment of M-Tracer and 3-D Human Model For Golf Swing Analysis Using Skeleton

(71) Applicant: Seiko Epson Corporation, Tokyo (JP)

(72) Inventors: Rouzbeh Maani, Toronto (CA); Jie Wang, Markham (CA); Hiu Lok Szeto, Richmond Hill (CA)

(21) Appl. No.: 15/243,557

(22) Filed: Aug. 22, 2016

(51) Int. Cl. G06T 7/20; G06T 7/60

(52) U.S. Cl. CPC G06T 7/2046; G06T 7/60; G06T 2207/10028; G06T 2207/30221; G06T 2207/10021; G06T 2207/30241

(57) ABSTRACT

A method for spatial alignment of golf-club inertial measurement data and a three-dimensional human skeleton model for golf club swing analysis are provided. The method includes capturing inertial measurement data of a golf club swing through an inertial measurement unit (IMU), and sending the inertial measurement data from the inertial measurement unit to a computing device. The computing device is configured to determine a three-dimensional trajectory in IMU coordinate space, determine in human model coordinate space a three-dimensional trajectory of a plurality of human skeleton points in a video with the video having depth or depth information, determine a transformation matrix from human model coordinate space to IMU coordinate space, and calculate an arm-golf club angle that is based on the inertial measurement data, the transformation matrix, and the three-dimensional trajectory of the plurality of human skeleton points.

### BACKGROUND

As an increasingly popular sport, golf has attracted millions of people around the world. Athletes and amateurs are always looking for ways to improve their skills. Sensor based golf coaching systems are commercially available. One such system provides an IMU (inertial measurement unit) sensor, denoted as M-Tracer™, on the golf club. The sensor tracks the golf club and outputs a high frequency swing trajectory as well as many other metrics such as impact speed, shaft angle etc. Although the sensor based golf coaching systems provide useful information, it is still difficult for a normal user to understand the information and link that information to his or her performance. It is within this context that the embodiments arise.

### SUMMARY

In some embodiments, a method for spatial alignment of golf-club inertial measurement data and a three-dimensional human skeleton model for golf club swing analysis is provided. The method includes capturing inertial measurement data of a golf club swing through an inertial measurement unit (IMU), and sending the inertial measurement data of the golf club swing from the inertial measurement unit to a computing device. The computing device is configured to determine a three-dimensional trajectory of the golf club swing in IMU coordinate space, determine in human model coordinate space a three-dimensional trajectory of a plurality of human skeleton points in a video of the golf club swing with the video having depth or depth information, determine a transformation matrix from human model coordinate space to IMU coordinate space, and calculate an arm-golf club angle that is based on the inertial measurement data of the golf club swing, the transformation matrix, and the three-dimensional trajectory of the plurality of human skeleton points.

In some embodiments, a method for spatial alignment of golf-club inertial measurement data and a three-dimensional human skeleton model for golf club swing analysis, performed by a computing device, is provided. The method includes receiving captured inertial measurement data of a golf club swing from an inertial measurement unit (IMU) and receiving or capturing a video with depth or depth information, of the golf club swing. The method includes determining a three-dimensional trajectory in human model coordinate space of a plurality of human skeleton points, based on detecting and tracking the plurality of human skeleton points in the video with depth or depth information and determining a three-dimensional trajectory in IMU coordinate space, from the inertial measurement data of the golf club swing. The method includes estimating a transformation matrix from the human model coordinate space to the IMU coordinate space and calculating an arm-golf club angle, based on the captured inertial measurement data of the golf club swing, the transformation matrix, and the three-dimensional trajectory of the plurality of human skeleton points.

In some embodiments, a tangible, non-transitory, computer-readable media having instructions thereupon which, when executed by a processor, cause the processor to perform a method. The method includes receiving, from an inertial measurement unit (IMU), inertial measurement data of a golf club swing and receiving, from at least a camera, a video of the golf club swing, having depth or depth information. The method includes determining, in human model coordinate space, a three-dimensional trajectory of a plurality of human skeleton points, based on detecting and tracking the plurality of human skeleton points in the video with depth or depth information and determining, in IMU coordinate space, a three-dimensional trajectory of the IMU, based on the inertial measurement data of the golf club swing. The method includes determining a transformation matrix from the human model coordinate space to the IMU coordinate space and calculating and outputting an arm-golf club angle, from the captured inertial measurement data of the golf club swing, the transformation matrix, and the three-dimensional trajectory of the plurality of human skeleton points.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIGS. 1A and 1B depict an inertial measurement unit (IMU) captured golf swing trajectory overlaid on a three-dimensional video, in a golf coaching system in accordance with some embodiments.

FIG. 2 is a flow diagram of a method for overlaying an IMU captured golf swing trajectory onto a three-dimensional video in accordance with some embodiments.

FIG. 3 is a view of a golf club with a ball marker in accordance with some embodiments.

FIG. 4 is a marker detection result in a near infrared (NIR) image in accordance with some embodiments.

FIG. 5 depicts a refinement process for refining marker positions with low confidence values in accordance with some embodiments.

FIG. 6 is a flow diagram of a method for determining arm-club and arm-floor angles in a golf swing analysis in accordance with some embodiments.

FIG. 7 depicts a human skeleton model in accordance with some embodiments.

FIG. 8 is an example of a skeleton detection result in accordance with some embodiments.

FIG. 9 illustrates estimating hand position by crossing elbow-hand lines in accordance with some embodiments.

FIG. 10 is a block diagram of a golf coaching system in accordance with the present disclosure.

FIG. 11 is a flow diagram of a method for spatial alignment of an inertial measurement unit captured golf club swing and a 3D human model of the golf club swing, with skeleton points of the human model in accordance with some embodiments.

FIG. 12 is an illustration showing an exemplary computing device which may implement the embodiments described herein.

### DETAILED DESCRIPTION

A golf coaching system for golf swing analysis performs spatial and temporal alignment of an inertial measurement unit (IMU) captured golf swing and a three-dimensional human model, based on a three-dimensional (3D) video of the golf swing, using an apparatus and various methods described herein. In one embodiment, the golf coaching system detects and tracks an infrared reflective marker, and uses this tracking for the spatial alignment. In another embodiment, the golf coaching system detects and tracks skeleton points, and uses this tracking for the spatial alignment. Also, the golf coaching system calculates an arm-golf club angle and an arm-floor angle for the golfer, from a three-dimensional human skeleton model based on the three-dimensional video and the spatial alignment with the IMU captured golf swing. These angles and various videos with overlays can be output by the system, for use in coaching a golfer. The methods can be performed on one or more processors, such as a processor of an IMU, a processor of a computing device and/or a processor of a mobile device (which could also be a computing device).

One device that is suitable for performing portions of various methods and serving as a portion of a suitable apparatus is the M-Tracer™ of the assignee, which is an IMU that can be mounted to a golf club. The M-Tracer™ is equipped with wireless communication, and can send IMU data to another wireless device. Although embodiments are described herein using the M-Tracer™ as an IMU in one embodiment, it should be appreciated that variations and further embodiments are readily devised using other IMU systems, as the embodiments are not limited to the M-Tracer™ product.

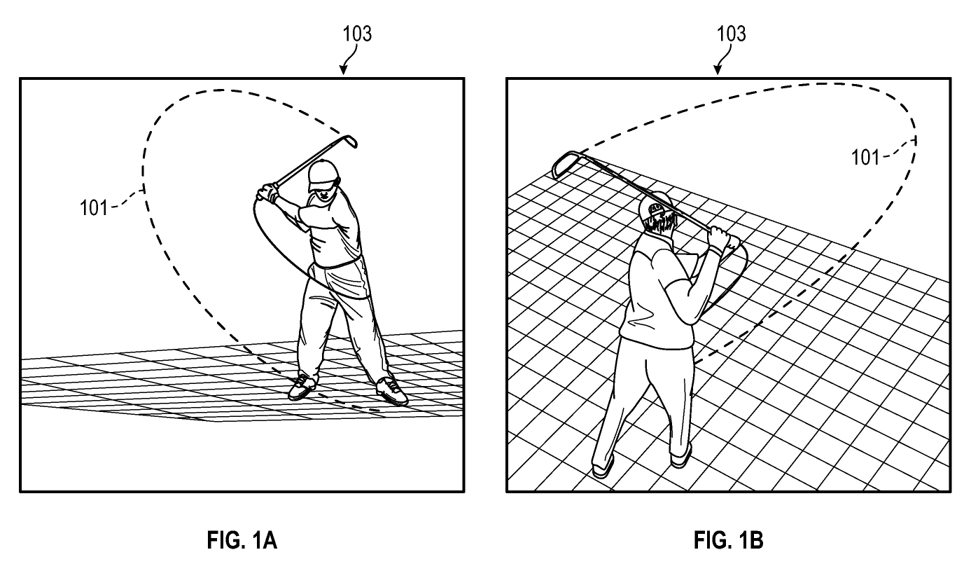

FIGS. 1A and 1B depict different view angles for an inertial measurement unit (IMU) captured golf swing trajectory 101 overlaid on a three-dimensional video 103, in a golf coaching system. Embodiments of the golf coaching system allow a user to directly see a visualization of the IMU system trajectory on top of his 3D swing video at any view angle, as viewed on a display screen of a computing device or mobile device such as a smartphone or a tablet as shown in FIGS. 1A and 1B. Using the golf coaching system, the golf swing trajectory of the golfer is captured by an IMU system attached to the golf club, while the three-dimensional video 103 is made, using a camera with depth or depth information such as a camera with depth sensors or a stereo camera (or even a plenoptic camera). The system develops a three-dimensional human model from the three-dimensional video 103, in some embodiments using a three-dimensional human skeleton model.

In this disclosure a method to automatically calibrate the IMU system and the 3D human model system is described. After calibration, the IMU system captured trajectory can be overlaid on top of the 3D video. The following is a method to spatially align the IMU system captured golf swing trajectory with a 3D human model based on 3D video captured by one or multiple depth sensors. Variations using other types of 3D video (e.g., stereo video) or 3D video captured by other types of cameras are readily devised, in keeping with the teachings herein. The method automatically estimates the transformation matrix from IMU system coordinate space to 3D human model coordinate space by aligning the IMU system swing trajectory with a detected IR (infrared) marker, which is attached on a hand or golf club. Variations with other types of markers are readily devised. The method has the following steps which will be explained further in more detail:
(1) Attach an IR reflective marker onto a golf club or golfer's hand.
(2) Capture RGBD (red, green, blue, depth) video (i.e., color, 3D video) of the golf swing using one or more depth sensors. Examples of depth sensors, such as RGBD sensors, can range from personal tablets or smart phones such as the Dell Venue 8 7000 series tablet and the Google Project Tango tablet for B2C (business to consumer) use case to more bulky but sophisticated sensors such as Kinect™ for B2B (business-to-business) use case.
(3) Reconstruct a 3D human model from the RGBD video.
(4) Detect and track the IR reflective marker from the RGBD video and obtain its 3D trajectory in human model coordinate space.
(5) Obtain the IMU system swing trajectory at the marker position.
(6) Estimate a transformation matrix from marker trajectory correspondences.

Although in theory only rigid transformation exists between the two coordinate systems, a perfect alignment cannot always be achieved due to error from the IMU system trajectory as well as marker detection. For a better visual alignment, a non-rigid transformation process can be followed in some embodiments.

Considering the fact that the IMU system trajectory may be inaccurate due to drifting error, a method to correct the IMU system trajectory includes the following steps:
(1) Set initial trajectory error vector as zero.
(2) Correct IMU system trajectory according a pre-defined error model.
(3) Estimate the rigid transformation matrix using marker trajectory and error corrected IMU system trajectory correspondences
(4) Estimate trajectory error by minimizing the distance between IMU system trajectory and a re-projected marker trajectory onto IMU system coordinate space.
(5) If the estimated trajectory error does not change or is sufficiently small, or maximum number of iterations is reached, go to (6), otherwise go to (2).
(6) Output the transformation matrix and a corrected IMU system trajectory.

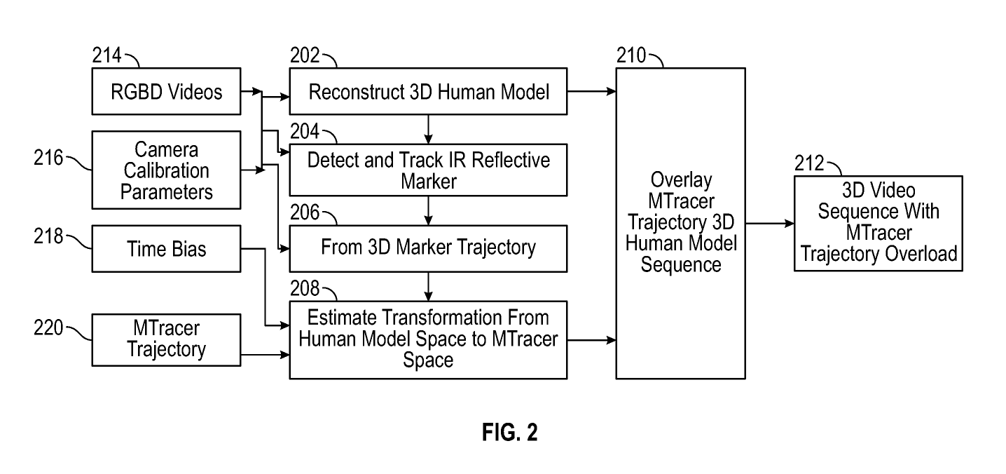

FIG. 2 is a flow diagram of a method for overlaying an IMU captured golf swing trajectory onto a three-dimensional video. One goal of present embodiments is to align the IMU system golf club swing trajectory with a human model by estimating the transformation from IMU system coordinate system to 3D human model coordinate system. FIG. 2 depicts the overall algorithm framework.

In an action 202, a 3D human model is reconstructed, based on three-dimensional video 214 and camera calibration parameters 216. In an action 204, an IR reflective marker is detected and tracked in the 3D video 214. In an action 206, a 3D marker trajectory is formed, based on the detection and tracking. In an action 208, a transformation from human model space to IMU system space is estimated, based on the IMU system trajectory 220 and a time bias 218 between the IMU system trajectory 220 and the 3D video 214. In an action 210, the IMU system trajectory 220 is overlaid onto a 3-D human model sequence, from the reconstructed 3-D human model in the action 202 and based on the transformation developed in the action 208. The output of these actions is a 3D video sequence with IMU system trajectory overlaid 212. The above actions can be performed by a computing device, more specifically by a processor, and can be performed by various modules which could be implemented in software executing on a processor, hardware, firmware, or combinations thereof.

The input to the system is one or multiple RGBD videos, camera calibration parameters, temporal synchronization information represented as time bias and IMU system trajectory. The system first reconstructs the human model from RGBD videos and detects the IR reflective marker for each video frame. 3D marker trajectory is then calculated by projecting 2D (two-dimensional) marker location into 3D space with known camera parameters. With the known temporal information represented as the time bias between the first video frame and the first IMU system frame, correspondences of the marker location in both coordinate spaces are then built. With such point correspondences, transformation between these two coordinate systems can thus be estimated. An algorithm is described below, in which an infrared (IR) reflective marker is used for detecting the location of the IMU on a golf club, in a video with depth or depth information, i.e., 3D video.

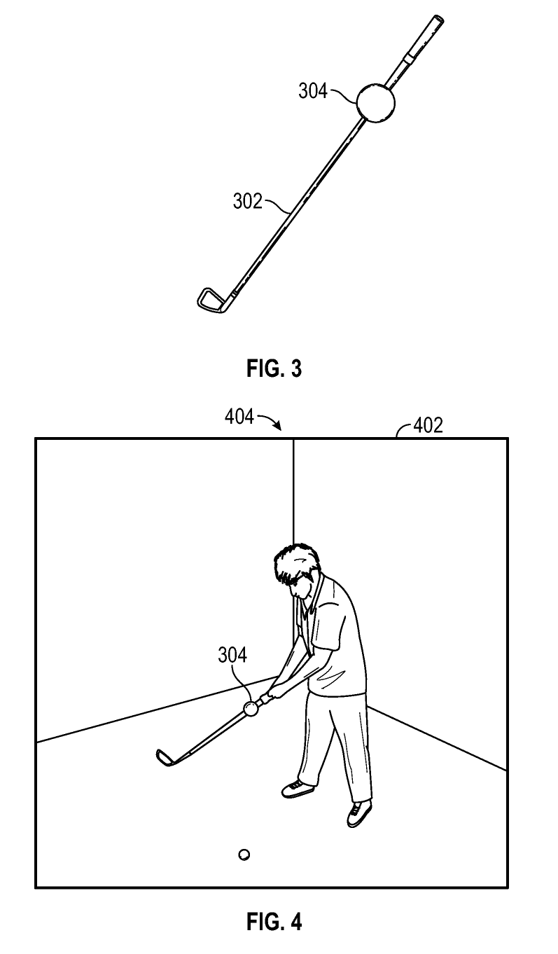

FIG. 3 is a view of a golf club 302 with a ball marker 304. Golf clubs are very thin and are usually dark color or shiny. It is often difficult for a depth sensor to capture a golf club accurately. In one embodiment, a sensor is used to capture RGBD video. It has been observed that a golf club is invisible in the depth images of this RGBD video. In such a case, tracking the golf club from the RGBD video is impossible. Therefore, in an embodiment, attaching an IR reflective marker 304 on the golf club 302 makes the marker visible in NIR (near infrared) images in the RGBD video. An example of the marker 304 is illustrated in FIG. 3, which is a white, soft ball that is attached around the IMU system. Thus the center of the ball can be reasonably accurately considered as the location of the IMU system. Another possible marker would be a golf club glove made of IR reflective material. The embodiments described herein do not limit the use of any specific marker or any specific marker location.

Reconstruction of a human model is described next. To capture RGBD video, a depth sensor is used in various embodiments. Due to the development of depth sensing technology, depth sensors are becoming more accessible and affordable for different ranges of users. Examples of RGBD sensors are given above, and use of further types of depth sensors to capture video with depth or depth information is readily devised.

Given one or multiple RGBD signals, the reconstruction of a 3D object model generally includes the following steps:
(1) camera calibration that includes optical calibration and RGB to depth calibration,
(2) extrinsic calibration of multiple RGBD sensors to figure out the geometric relationship between each other,
(3) target object segmentation,
(4) surface reconstruction including depth fusion, triangulation and
(5) texture mapping.
   In some embodiments, the Holocam system is used to construct a real time human model from four Kinect™ sensors. However, embodiments are not limited to any specific model reconstruction method. Other literature available methods can be applied and integrated with the embodiments, such as real time Kinect™ fusion.

Detection of an IR reflective marker is described below. FIG. 4 is a marker detection result 404 in a near infrared image 402. To obtain the 3D coordinates of the marker 304 in human model space, the system first detects the marker 304 in the 2D NIR image 402 followed by a step of estimating the 3D location of the marker 304 using camera calibration information. As the marker 304 is an IR reflective marker, it is visible in the NIR image 402. In this embodiment, the system detects the marker by detecting a ball shape in the image 402. A Canny edge detector is applied on the background subtracted image and a circle Hough transform is followed to detect ball marker candidates and pick the ball marker candidate that has the highest matching score with a circle pattern. After detecting marker position for all frames, a refinement process is followed by re-estimating the marker location at those frames with low matching score. The refined position is estimated by interpolating the detected marker position from the neighboring frames with high matching scores. An example of a detection result is depicted in FIG. 4. A detailed description of a suitable detection algorithm is provided following the description of the IMU system trajectory correction. Although a particular marker detection algorithm is disclosed herein, the proposed method does not limit the use of a specific marker, thus, different marker detection algorithms can be applied without invalidating the disclosed pipeline.

Estimating the three-dimensional location of the marker is described below. If only one depth sensor is used, the 3D location of the marker, denoted as P=[X, Y, Z]^{T} can be directly obtained from its 2D location, denoted as q=[x, y]^{T} with the known camera intrinsics, i.e.,

$$X = \frac{x - {C}_{x}}{{f}_{x}} Depth ( x , y ) , \\ Y = \frac{y - {C}_{y}}{{f}_{y}} Depth ( x , y ) , \\ Z = Depth ( x , y ) \qquad ( Eq . 1 )$$

where Cₓ, C_{y}, fₓ, f_{y} are intrinsic parameters and depth(x, y) denote the depth reading at location of (x, y)

If multiple depth sensors are used to capture the swing simultaneously, the 3D location in human model coordinate space, denoted as Pₜ, is found by minimizing the re-projection error for all N sensors:

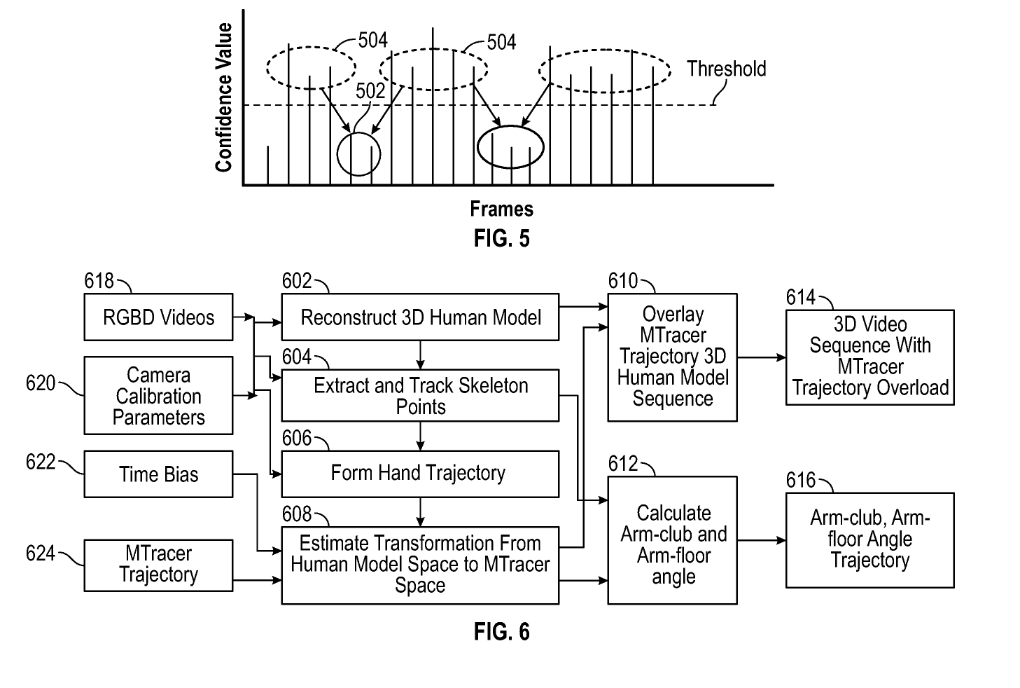

argmin_{P}_{ₜ} Σᵢ₌₁^{N}∥q_{i,t}−π(Kᵢ, Tᵢ, Pₜ)∥² (Eq. 2)

where q_{i,t} is the detected 2D marker location point at frame t for i^{th} sensor, Kᵢ and Tᵢ the intrinsic and extrinsic matrices of i^{th} sensor and it is the projection operator transforming a 3D point from model coordinate space to i^{th} sensor image space. Various optimization procedures can be used to solve the above minimization problem to get the optimal 3D marker location Pₜ. One implementation of the optimization is detailed below with reference to FIG. 5.

Estimating the transformation is described next. Assuming the temporal synchronization is completed, e.g., by aligning an IMU system sampling frame to a video frame and/or optimizing such alignment, marker position correspondences can then be built. Let Pₜ, t=1, . . . , N denote the 3D coordinates of marker at time t represented in human model coordinate space, and let Mₜ denote the corresponding marker positions represented in M-Tracer™ coordinate space. Thus the goal is to estimate a rigid transformation matrix that includes a rotation R, a translation T and a scaling factor s such that Pₜ=sRMₜ+T
The closed-from solution of absolute orientation using unit quaternions is used to find s, R and T.

Although in theory only rigid transformation exists between the two coordinate systems, a perfect alignment is difficult to achieve due to error from M-Tracer™ trajectory as well as marker detection. For a better visual alignment, a non-rigid transformation process can be followed. For instance, Gaussian Mixture Models is a robust method that can handle noise and outliers well. The non-rigid transformation provides the final 3D location of the golf club head and grip in the human model coordinate space.

Correction of the IMU captured golf club trajectory is described next. The M-Tracer™ trajectory is not always accurate. As with any IMU sensor tracking algorithm based on integrating acceleration and rotational velocity, the IMU system trajectory suffers from drifting error as any small error will be accumulated through the integration process. It usually requires another piece of signal information to correct it. Thus, some embodiments of the system correct M-Tracer™ drifting error by using information from the marker trajectory. Let [symbol] denote the unknown true value of M-Tracer™ trajectory that can be obtained from the observed trajectory Mₜ according to a pre-defined error model [symbol] =F(Mₜ, εₜ), where εₜ denotes the error vector and F(.) defines the error model. For one embodiment, pseudo code for the method is illustrated as below.

Input: Pₜ, t=1, . . . , N denote the marker 3D positions at time t represented in human model coordinate space,

Mₜ i=1, . . . , N denote corresponding marker position at time t represented in M-Tracer™ coordinate space,
Algorithm:
(1) Set εₜ(0)=\vec{0}; n=1;
(2) Estimate transformation matrix Tr=[sR|T] using [symbol] =F(Mₜ, εₜ(n−1)) and Pₜ correspondences
(3) Re-project Pₜ to M-Tracer™ space, i.e., Tr⁻¹Pₜ
(4) Estimate error vector εₜ(n) by minimizing 1/N Σᵢ∥F(Mᵢ, εᵢ(t))−Tr⁻¹Pᵢ∥²
(5) If 1/n Σₜ∥εₜ(n)∥ is smaller than a threshold, or 1/n Σₜ∥εₜ(n)−εₜ(n−1)∥ is smaller than a threshold, or n is larger than a threshold

output corrected trajectory [symbol] , and transformation matrix Tr
otherwise

n=n+1;

go to (2)

The definition of the error model depends on the sensor properties. In this disclosure, this is not limited to any specific error model. The above method can also be used to correct club head trajectory if the golf club head can be detected and tracked in the RGBD video sequence.

For IMU two-dimensional location detection, an algorithm to detect the white ball marker works as follows:
For each sensor
(1) Make background image BG
(2) Find circles and their confidence for the first frame I₁=I₁−BG, set MarkerLocation=[x, y, c] and set PrevLocation=[x, y, c]
(3) For all frames Iⱼ, j={2, . . . , End}

Iⱼ=Iⱼ−BG

Find circles and their confidence
If no circle is found

add PrevLocation to MarkerLocation
else

Choose the circle center (x, y) with the highest confidence value c and

add [x, y, c] to MarkerLocation

Set PrevLocation to [x, y, c]
(4) Refine MarkerLocation

The next subsections explain the details of the algorithm to detect the location of the IMU system (e.g., a white IR reflective ball or other marker attached to the golf club) in NIR images of the 3D video.

Background Subtraction is performed. In order to find the location of the marker (e.g., white ball around IMU system) in a frame, first a background model is constructed. The background model is the average of the frames:

$$BG = \frac{1}{e - s} {\sum }_{i = s}^{e} {I}_{i} ,$$

where s and e represent the first and last frames to average. The best range [s e] is the range covering fast moving frames (e.g., golf club top position to impact). For the frame Iᵢ, the background is subtracted and used for the next step processing.

Iᵢ=Iᵢ−BG.

Circle detection and confidence determination are performed. First, edges in the given image are detected by finding pixels with high gradient magnitude. Then, the circle Hough transform is applied to find the center and radius of the ball marker candidates (i.e., [x_{ball}ⁱ, y_{ball}ⁱ, r_{ball}ⁱ]). The detection confidence of a circle cᵢ in image I is computed as:

cᵢ=I*kᵢ,

where kᵢ is the kernel defined for circle i, [x_{ball}ⁱ, y_{ball}ⁱ, r_{ball}ⁱ], i.e.,

$${k}_{i} ( x , y , {x}_{ball}^{i} , {y}_{ball}^{i} , {r}_{ball}^{i} ) \text{:} \{ \begin{matrix}0.5 & if \sqrt{{( x - {x}_{ball}^{i} )}^{2} + {( y - {y}_{ball}^{i} )}^{2}} \leq {r}_{ball}^{i} \\ - 0.5 & if {r}_{ball}^{i} < \sqrt{{( x - {x}_{ball}^{i} )}^{2} + {( y - {y}_{ball}^{i} )}^{2}} \leq {r}_{ball}^{i} \times 1.5 \\ 0 & otherwise\end{matrix} .$$

The ball marker [x_{ball}, y_{ball}] is thus detected as the circle candidate that has the maximum confidence value.

Detection refinement is performed. To refine the results, the system reviews the confidence values of the detected marker position of all frames and re-estimates those frames with low confidence value (below the given Threshold) by interpolating the results from one or more neighboring frames that has high confidence value, as illustrated in FIG. 5.

FIG. 5 depicts a refinement process for refining marker positions with low confidence values. Marker position(s) with low confidence values 502 are refined using left and right neighboring high confidence frames 504 through an interpolation process. As

IMU system 3D location estimation can be performed by the system as follows. In order to find the 3D location of the IMU system from 2D positions detected in the previous step, minimize re-projection error for all N sensors:

$$arg {min}_{{P}_{t}} {\sum }_{i = 1}^{N} {‖ {q}_{i , t} - π ( {K}_{i} , {T}_{i} , {P}_{t} ) ‖}^{2}$$

where q_{i,t,} is the detected 2D point at time t for senor i, Kᵢ and Tᵢ are the intrinsic and extrinsic matrices of senor i, and π is the projection operator and Pₜ is the 3D coordinate of the marker in model coordinate space that is estimated from all sensors. The algorithm is explained below:

Step 1: Find initial Pₜ,
For all q_{i,t}, i={1, . . . , N}
(1) Set [P_{i,t}, Valid_{i,t}]=D(q_{i,t}, Tᵢ), where D( ) denote the function to find the 3D position of q_{i,t}, denoted as P_{i,t}, using depth information and extrinsic parameters of senor i according Eq. (1). If there is no depth info, then the result is invalid, i.e., Valid_{i,t}=0, otherwise Valid_{i,t}=1
(2) If Σᵢ₌₁^{N} Valid_{i,t}<1
Stop and return: No valid 3D point is detected at time t
(3) Set Pₜ=argmin_{P}_{_{i,t}} Σᵢ₌₁^{N}∥q_{i,t}−π(Kᵢ, Tᵢ, P_{i,t})∥².Valid_{i,t},
(4) Set

$${P}_{mean} = \frac{1}{{\sum }_{i = 1}^{N} {Valid}_{i , t}} {\sum }_{i = 1}^{N} {P}_{i , t} \cdot {Valid}_{i , t} ,$$

(5) if Σᵢ₌₁^{N}∥q_{i,t}−π(Kᵢ, Tᵢ, Pₘₑₐₙ)∥²<Σᵢ₌₁^{N}∥q_{i,t}−π(Kᵢ, Tᵢ, Pₜ)∥²

Set Pₜ=Pₘₑₐₙ

Step 2: Find final Pₜ which minimizes re-projection error
Set Pₜ=argmin_{P}_{_{i,t}} Σᵢ₌₁^{N}∥q_{i,t}−π(Kᵢ, Tᵢ, P_{i,t})∥².Valid_{i,t}
(6) Calculate averaged re-projection error

$$Err = \frac{1}{{\sum }_{i = 1}^{N} {Valid}_{i , t}} {\sum }_{i = 1}^{N} {‖ {q}_{i , t} - π ( {K}_{i} , {T}_{i} , {P}_{t} ) ‖}^{2} \cdot {Valid}_{i , t}$$

(7) if Err>ThresholdError
(a) Remove the outlier q_{i,t} which has the largest re-projection error:
argmax_{q}_{_{i,t}} Σᵢ₌₁^{N}∥q_{i,t}−π(Kᵢ, Tᵢ, P_{i,t})∥².Valid_{i,t}, by setting Valid_{i,t}=0
(b) Set Pₜ=argmin_{P}_{_{i,t}} Σᵢ₌₁^{N}∥q_{i,t}−π(Kᵢ, Tᵢ, P_{i,t})∥².Valid_{i,t}
(c) Calculate the averaged re-projection error

$$Err = \frac{1}{{\sum }_{i = 1}^{N} {Valid}_{i , t}} {\sum }_{i = 1}^{N} {‖ {q}_{i , t} - π ( {K}_{i} , {T}_{i} , {P}_{i , t} ) ‖}^{2} \cdot {Valid}_{i , t} ,$$

(d) Do the following T times or until Err<ThresholdError

a. Find q_{i,t} with maximum error, i.e.,
argmax_{q}_{_{i,t}} Σᵢ₌₁^{N}∥q_{i,t}−π(Kᵢ, Tᵢ, P_{i,t})∥².Valid_{i,t}, and replace it with a pixel within a window W around q_{i,t} which minimizes the re-projection error:

$${q}_{i , t} = \begin{matrix}argmax \\ q ∈ W ( {q}_{i , t} )\end{matrix} {‖ q - π ( {K}_{i} , {T}_{i} , {P}_{t} ) ‖}^{2} \cdot {Valid}_{i , t}$$

b. Set Pₜ=argmin_{P}_{_{i,t}} Σᵢ₌₁^{N}∥q_{i,t}−π(Kᵢ, Tᵢ, P_{i,t})∥².Valid_{i,t}

c. Set

$$Err = \frac{1}{{\sum }_{i = 1}^{N} {Valid}_{i , t}} {\sum }_{i = 1}^{N} {‖ {q}_{i , t} - π ( {K}_{i} , {T}_{i} , {P}_{t} ) ‖}^{2} \cdot {Valid}_{i , t} ,$$

Otherwise go to (8)
(8) Output Pₜ

A method performed by the golf coaching system to automatically calibrate the IMU system and the 3D human model system is described below. After calibration, the IMU system capture trajectory can be overlaid on top of the 3D video. The apparatus and method spatially aligns the IMU system captured golf swing trajectory with the 3D human model based on 3D video captured by one or multiple depth sensors. The method can automatically estimate the transformation matrix from IMU system coordinate space to 3D human model coordinate space aligning the detected human skeleton points with the swing trajectory. One embodiment has the following steps:
(1) Capture RGBD video of the golf swing using a depth sensor. As above, examples of depth sensors can range from personal tablet or smart phone such as Dell Venue 8 7000 series tablet and Project Tango Tablet for B2C use case to more bulky but sophisticated sensors such as Kinect™ for B2B use case.
(2) Detect and track various human skeleton points, e.g., hand, wrist, elbow, foot, etc.
(3) Obtain IMU system swing trajectory at grip position.
(4) Obtain hand trajectory from skeleton tracking.
(5) Estimate transformation matrix from IMU system and skeleton trajectory correspondences.
(6) Calculate arm-club angle and track such angle from address to swing end. The method includes:
   a. Get 3D coordinates of the golf club head in the IMU system coordinate space from the IMU system trajectory.
   b. Calculate 3D coordinates of the golf club head in human model coordinate space by applying the transformation from (5).
   c. Get 3D coordinates of hand and elbow points in human model coordinate space from skeleton tracking.
   d. Calculate the angle between lines defined by hand-club head and hand-elbow in human model coordinate space.
(7) Calculate the arm-floor angle for each frame and track such angle from address to swing end. The method includes:
   a. Get 3D coordinates of left and right foot points at address time in human model coordinate space from skeleton tracking.
   b. Get 3D coordinates of golf club head at address time in IMU system coordinate space from IMU system trajectory.
   c. Calculate 3D coordinates of club head in human model coordinate space by applying the transformation from (5).
   d. Define the floor plane using left, right foot points from (a) and golf club head location from (c) in human model coordinate space.
   e. Calculate the angle between a line defined by hand-elbow and the floor plane estimated from (d).

Although in theory only rigid transformation exists between the two coordinate systems, a perfect alignment cannot always be achieved due to error from the IMU system trajectory as well as skeleton detection. For a better visual alignment, a non-rigid transformation process can be followed.

Considering that the IMU system trajectory may be inaccurate due to drifting error, the system can perform a process to correct the IMU system trajectory that includes the following steps:
(1) Set initial trajectory error vector as zero.
(2) Correct IMU system trajectory according a pre-defined error model.
(3) Estimate the rigid transformation matrix using hand trajectory and error corrected IMU system trajectory correspondences.
(4) Estimate trajectory error by minimizing the distance between the IMU system trajectory and a re-projected hand trajectory onto IMU system coordinate space.
(5) If the estimated trajectory error does not change or is sufficiently small, or a maximal number of iterations is reached, go to (6), otherwise go to (2)
(6) Output the transformation matrix and a corrected IMU system trajectory.

One goal of present embodiments is to align IMU system trajectory with a 3D human model by estimating the transformation from IMU system coordinate system to 3D human model coordinate system. One goal of a further embodiment, described below, is to determine and output an angle between an arm of a golfer and the golf club, and also determine and output an angle between the arm of the golfer and the floor. Knowledge of these angles is useful in coaching the golfer for improvement in golf swing. FIG. 2 depicts the overall algorithm framework.

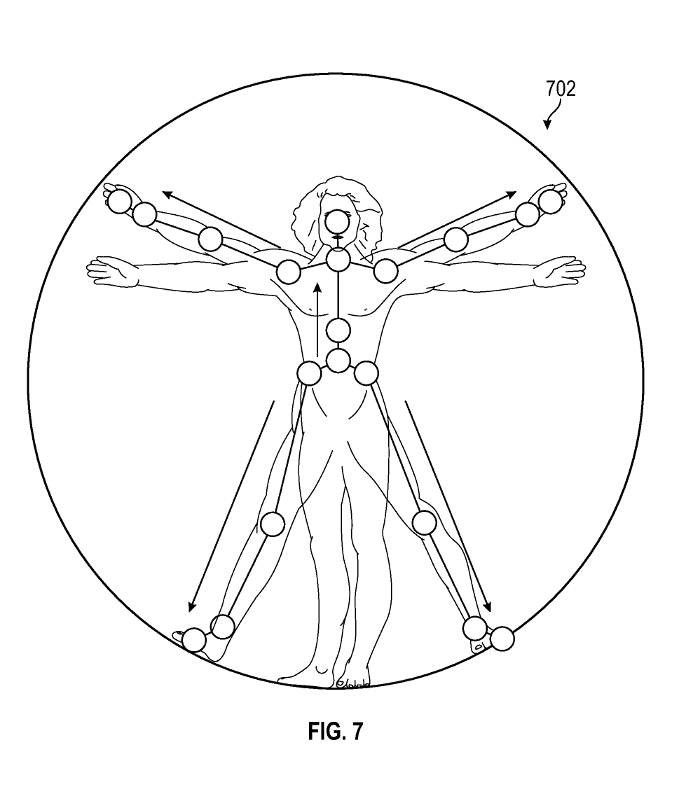

FIG. 6 is a flow diagram of a method for determining arm-club and arm-floor angles in a golf swing analysis. The method is practiced by embodiments of the golf coaching system, as a variation of the embodiments described above with reference to FIGS. 1-5. In an action 602, the 3D human model is reconstructed, based on the three-dimensional video 618 and the camera calibration parameter 620. In an action 604, skeleton points are extracted and tracked, based on the three-dimensional video 618 and the 3D human model reconstructed in the action 602. In an action 606, the hand trajectory is formed, based on the tracked skeleton points from the action 604. In an action 608, the transformation from human model space to the IMU system is estimated, using the time bias 622 and the IMU system trajectory 624. In an action 610, the IMU system trajectory is overlaid onto a 3D human model sequence, based on the reconstructed 3D human model from the action 602 and the transformation matrix from the action 608. A 3D video sequence with IMU system trajectory overlaid is produced in an action 614. In an action 612, the arm-club angle and the arm-floor angle are calculated, based on the tracked skeleton points from the action 604 and the transformation matrix from the action 608. The arm-club and arm-floor angle trajectory are output, in an action 616.

The inputs to the system are one or multiple RGBD videos, camera calibration parameters, IMU system trajectory and temporal synchronization information represented as time bias between the first video frame and the first frame of IMU system signal. The system reconstructs the human model from RGBD videos and detects the skeleton points for each video frame. Hand trajectory is then extracted by averaging either left and right hand or left and right wrist skeleton points. With the pre-known temporal information, the hand and IMU system grip position trajectory correspondences are then built. With such point correspondences, transformation between these two coordinate systems can thus be estimated.

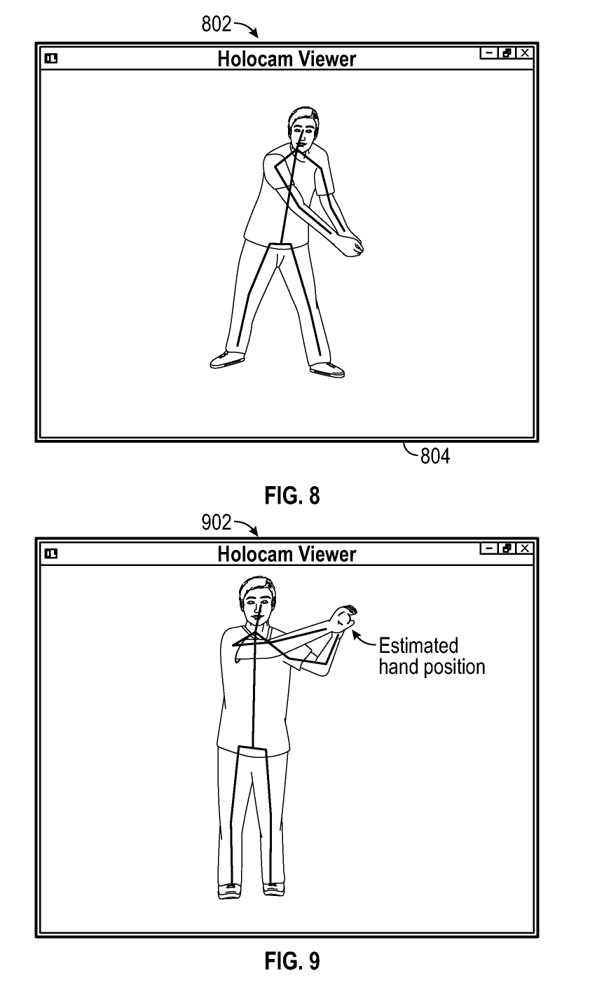

FIG. 7 depicts a human skeleton model. In one embodiment, the system uses the a skeleton detection and tracking method, which can be obtained directly from the Kinect™ SDK (software development kit) in some embodiments. The human skeleton 702 definition is illustrated in FIG. 7 in accordance with some embodiments. For a specific skeleton point, if multiple skeleton signals are available from different sensors, a merging step is required. Embodiments are not limited to any specific skeleton detection, tracking and merging algorithm. Various methods that generate 3D skeleton trajectory in a world space can be applied. An example of the detected skeleton is illustrated in FIG. 8.

FIG. 8 is an example of a skeleton detection result. Detected and reprojected skeleton lines 802 are seen overlaid onto a video frame of a golfer in mid-swing. The system extracts the hand trajectory, based on these skeleton lines and detected skeleton points. In order to estimate the transformation between model space and IMU system space, the system builds correspondences between feature points in those two spaces. The IMU system can output trajectory of grip position with pre-known distance between hand and IMU system location. This pre-known distance can be measured and input into the system through user input, or determined by the system through measurement in video frames and scaling. Thus, the hand trajectory from human model is extracted to build such correspondences.

FIG. 9 illustrates estimating hand position by crossing elbow-hand lines 902. During the golf swing, the user holds the golf club with two hands together. One technique to get the hand position is to average the left and right hand positions output from the Kinect™ SDK. In addition to using hand position, wrist position can also be used as the estimation of grip position on the golf club, by averaging left and right wrist positions. In a more sophisticated way, these four points can be combined to provide a more robust estimation. An alternative way to estimate the hand position is to extend the left and right elbow-hand/wrist line and use the cross point as the estimation of hand position.

Similarly to previously described embodiments, the system estimates a transformation. Assuming temporal synchronization is completed, e.g., using temporal synchronization information provided as a time bias, hand position correspondences can then be built. Let Pᵢ, i=1, . . . , N denote the 3D coordinates of the hand at time i represented in human model coordinate space obtained from skeleton tracking, and let Mᵢ denote the corresponding grip point positions represented in M-Tracer™ coordinate space. Thus the goal is to estimate a rigid transformation matrix that includes a rotation R, a translation T and a scaling factor s such that

Pᵢ=sRMᵢ+T

The closed-form solution of absolute orientation using unit quaternions [4] is used to find s, R and T.

Although in theory only rigid transformation exist between two coordinate systems, a perfect alignment is difficult to achieve due to error from the IMU system trajectory as well as skeleton detection. For a better visual alignment, a non-rigid transformation process can be followed. For instance, Gaussian Mixture Models is a robust method that can handle noise and outliers well. The non-rigid transformation provides the final 3D location of the golf club head and grip in the human model coordinate space.

Arm-club angle and arm-floor angle are two important measurements that can help golfers to improve their skills. With the calculated transformation matrix, the IMU system trajectory is projected to human model coordinate space. Let Pᵢ^{e} and Pᵢ^{ha} denote the 3D coordinates of elbow position and hand position in the human model coordinate space obtained from skeleton tracking. Let Mᵢ^{h} be 3D coordinate of club head position at time i output by the IMU system, its corresponding coordinates in human model space, denoted as Pᵢ^{h}, can then be calculated as

Pᵢ^{h}=sRMᵢ^{h}+T

Then, the angle between arm and club, denoted as θ_{ac}, is defined as the angle between club line [Pᵢ^{ha}, Pᵢ^{h}] and arm line [Pᵢ^{ha}, Pᵢ^{e}]. This angle can be calculated as

$${θ}_{ac} = acos ( \frac{( {P}_{i}^{ha} - {P}_{i}^{h} ) \cdot ( {P}_{i}^{ha} - {P}_{i}^{e} )}{\vert {P}_{i}^{ha} - {P}_{i}^{h} ‖ {P}_{i}^{ha} - {P}_{i}^{e} \vert} ) ,$$

where (·) denotes the dot product operator and |.| is the norm operator.

To calculate the arm-floor angle, the floor plane normal is defined, denoted as \vec{n}. In one embodiment, Holocam technology is used by the system to reconstruct the human model. In Holocam space definition, z axis is defined as the normal to the floor plane pointing upward, i.e., \vec{n}=[0,0,1]^{T}. If some other model reconstruction method is used while the floor plane is not explicitly defined, an embodiment of the system could estimate the floor plane using 3D positions of the golf club head, left foot and right foot during address time. Let P_{ad}^{lf} and P_{ad}^{rf} denote the 3D coordinates of left and right foot at address time in the human model coordinate space obtained from skeleton tracking. Let the P_{ad}^{h} be the 3D coordinates of the golf club head at address time in human model coordinate space. The floor plane normal can thus be estimated as

$$\vec{n} = \frac{( {P}_{ad}^{lf} - {P}_{ad}^{h} ) \times ( {P}_{ad}^{rf} - {P}_{ad}^{h} )}{\vert ( {P}_{ad}^{lf} - {P}_{ad}^{h} ) \times ( {P}_{ad}^{rf} - {P}_{ad}^{h} \vert}$$

Then, the angle between arm and floor plane, denoted as θ_{af}, can be calculated as

$${θ}_{af} = acos ( \frac{\vec{n} \cdot ( {P}_{i}^{ha} - {P}_{i}^{e} )}{\vert {P}_{i}^{ha} - {P}_{i}^{e} \vert} ) ,$$

Various embodiments of the golf coaching system correct the IMU system trajectory. The IMU system trajectory is not always accurate. As with any IMU sensor tracking algorithm based on integrating acceleration and rotational velocity, the IMU system trajectory suffers from drifting error, as any small error is accumulated through the integration process. The trajectory may require another piece of signal information to correct it. Thus, some embodiments of the system correct IMU system drifting error by using the information from the skeleton trajectory. Let [symbol] denote the unknown true value of IMU system trajectory that can be obtained from the observed trajectory Mᵢ according to a pre-defined error model [symbol] =F(Mᵢ, εᵢ), where εᵢ denotes the error vector and F(.) defines the error model. With pseudo code, one embodiment of the method is illustrated as below.

```
          Input: Pᵢ, i = 1, . . . , N denote the hand 3D positions at time i represented in
human model coordinate space,
  Mᵢ i = 1, . . . , N denote corresponding grip point positions at time i represented in M-
Tracer ™ coordinate space,
Algorithm:
          (1) Set εᵢ(0) = \vec{0} ; t = 1;
          (2) Estimate transformation matrix Tr = [sR|T] using [symbol]     = F(Mᵢ , εᵢ(t − 1)) and Pᵢ
      correspondences
          (3) Re-project Pᵢ to M-Tracer ™ space, i.e., Tr(t)⁻¹Pᵢ
          (4) Estimate error vector εᵢ(t) by minimizing 1/N Σᵢ ∥F (Mᵢ , εᵢ(t)) − Tr⁻¹Pᵢ∥²
          (5) If 1/n Σᵢ ∥εᵢ₍ₜ₎∥ is smaller than a threshold, or 1/n Σᵢ ∥εᵢ(t) − εᵢ(t − 1)1∥ is
smaller than a threshold, or it is larger than a threshold
        output corrected trajectory [symbol]    , and transformation matrix Tr
otherwise
  t = t + 1;
  go to (2)
```

The definition of the error model depends on the sensor properties. In this disclosure, embodiments are not limited to any specific error model. The above method can also be used to correct club head trajectory if the golf club head can be detected and tracked in the RGBD video sequence.

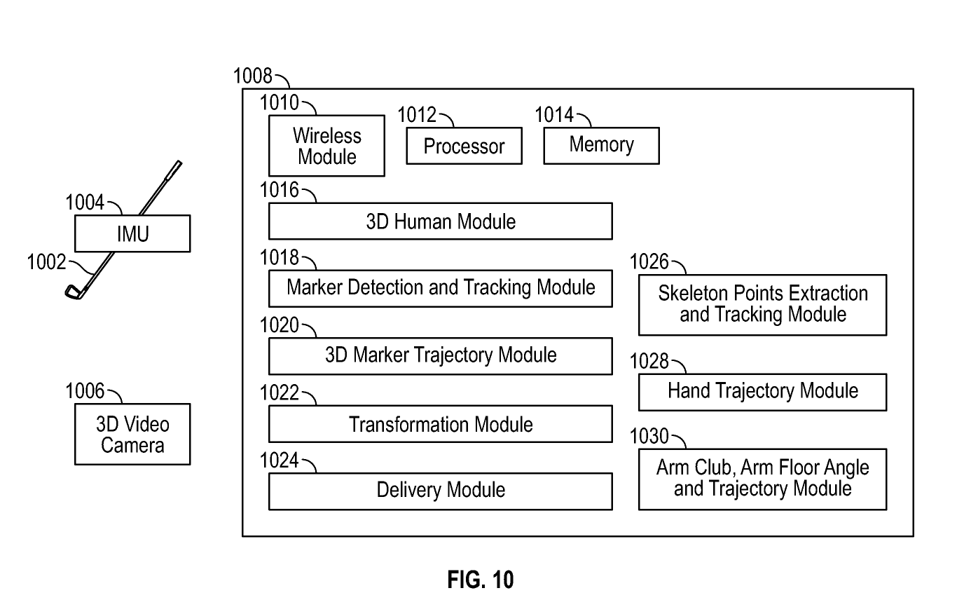

FIG. 10 is a block diagram of a golf coaching system in accordance with the present disclosure. An inertial measurement unit 1004, such as the IMU system described herein, is attached to a golf club 1002, and is used for capturing inertial measurement of a golf club swing by a golfer. A 3D video camera 1006 captures a three-dimensional video of the golf club swing. A computing device 1008 has a processor 1012, a memory 1014, and a wireless module 1010. The computing device receives captured inertial measurement of the golf club swing from the inertial measurement unit 1004 attached to the golf club 1002, via the wireless module 1010 of the computing device 1008. Also, the computing device receives the captured three-dimensional video from the 3-D video camera 1006, via a wired or a wireless connection, or other transfer mechanism. In further embodiments, wired connections or media transfer could be used.

The computing device 1008 has a 3D human model module 1016, a marker detection and tracking module 1018, a 3D marker trajectory module 1020, a transformation module 1022, an overlay module 1024, a skeleton point extraction and tracking module 1026, a hand trajectory module 1028, and an arm-club, arm-floor angle and trajectory module 1030. Each of these modules could be implemented in software executing on the processor 1012, hardware, firmware, or combination thereof. These modules implement functions described above with reference to FIGS. 1-9. The computing device 1008 forms a 3D human model, with a skeleton model in some embodiments, based on the 3D video of the golf club swing, detects and tracks a marker and forms a 3D trajectory of the marker, and determines a transformation between the IMU system trajectory and the 3D human model, with alignment based on the 3D trajectory of the marker. Alternatively, the computing device 1008 tracks skeleton points from the skeleton model, and determines the transformation between the IMU system trajectory and the 3-D human model, with alignment based on the tracked skeleton points. The computing device 1008 overlays the IMU system trajectory onto the 3D human model, and displays this for viewing at a user-selected angle. Alternatively the computing device 1008 sends a 3-D video to a user device for viewing at a user-selected angle, which can be selected or manipulated through user input. Also, the computing device 1008, in some embodiments, calculates an arm-club angle and/or an arm-floor angle, and/or trajectories for one or both of these, and outputs one or both of these angles and/or trajectories overlaid on the 3D human model, the 3-D human model with skeleton model overlay, the 3D video, or the 3-D video with skeleton model overlay. Variations include various combinations of these features.

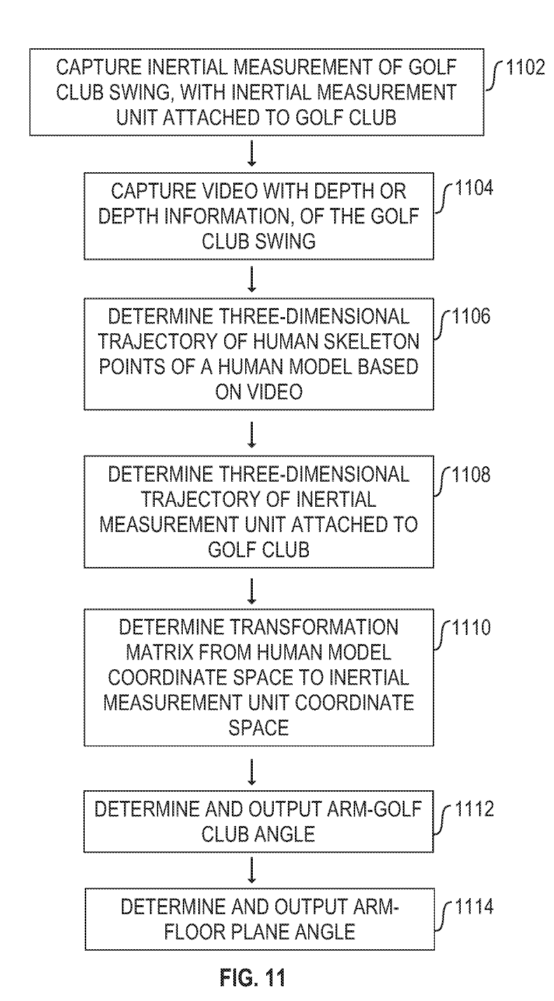

FIG. 11 is a flow diagram of a method for spatial alignment of an inertial measurement unit captured golf club swing and a 3D human model of the golf club swing, with skeleton points of the human model. The method is practiced by components of the golf coaching system, and particularly by one or more processors of a computing device with various modules as described above. In an action 1102, inertial measurement of a golf club swing is captured with (or by) an inertial measurement unit attached to a golf club. In an action 1104, video with depth or depth information (i.e., 3D video) of the golf club swing is captured, e.g., by a 3D video camera such as a stereo camera or a camera with one or more depth sensors. In an action 1106, a three-dimensional trajectory of human skeleton points of a human model is determined, based on the video, e.g., by a computing device that receives the captured inertial measurement of the golf club swing and the captured 3D video of the golf club swing. In an action 1108, a three-dimensional trajectory of the inertial measurement unit attached to the golf club is determined, by the computing device. In an action 1110, a transformation matrix from human model coordinate space to inertial measurement unit coordinate space is determined, by the computing device. The transformation matrix is based on correspondence between the tracking of the human skeleton points and the three-dimensional trajectory of the inertial measurement unit attached to the golf club. In an action 1112, an angle of an arm and a golf club is determined and output. In an action 1114, an angle on an arm and a floor plane is determined and output. These angles are determined based on the determined three-dimensional trajectory of the inertial measurement unit attached to the golf club, the determined three-dimensional trajectory of the human skeleton points in human model space, and the transformation matrix. In some embodiments, these angles are determined as three-dimensional trajectories, and overlaid onto the three-dimensional video or onto a three-dimensional human model. In some embodiments, this is combined with a three-dimensional human skeleton model overlaid onto the three-dimensional human model or overlaid onto the three-dimensional video (i.e., the video with depth or depth information). In some embodiments, the computing device displays, or sends to a mobile device for display, some or all of the above results, which the user can view at one or more selected angles of view, e.g., as manipulated or selected by user input.

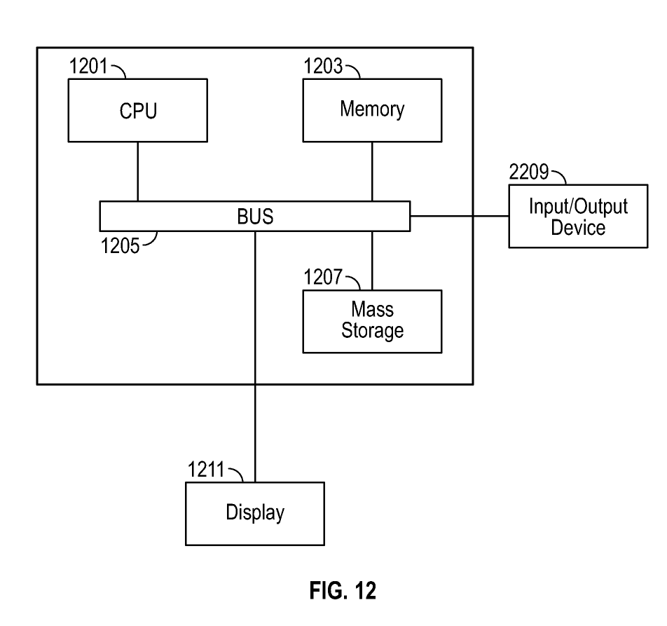

It should be appreciated that the methods described herein may be performed with a digital processing system, such as a conventional, general-purpose computer system. Special purpose computers, which are designed or programmed to perform only one function may be used in the alternative. FIG. 12 is an illustration showing an exemplary computing device which may implement the embodiments described herein. The computing device of FIG. 12 may be used to perform embodiments of the functionality for a golf coaching system in accordance with some embodiments. The computing device includes a central processing unit (CPU) 1201, which is coupled through a bus 1205 to a memory 1203, and mass storage device 1207. Mass storage device 1207 represents a persistent data storage device such as a floppy disc drive or a fixed disc drive, which may be local or remote in some embodiments. The mass storage device 1207 could implement a backup storage, in some embodiments. Memory 1203 may include read only memory, random access memory, etc. Applications resident on the computing device may be stored on or accessed via a computer readable medium such as memory 1203 or mass storage device 1207 in some embodiments. Applications may also be in the form of modulated electronic signals modulated accessed via a network modem or other network interface of the computing device. It should be appreciated that CPU 1201 may be embodied in a general-purpose processor, a special purpose processor, or a specially programmed logic device in some embodiments.

Display 1211 is in communication with CPU 1201, memory 1203, and mass storage device 1207, through bus 1205. Display 1211 is configured to display any visualization tools or reports associated with the system described herein. Input/output device 1209 is coupled to bus 1205 in order to communicate information in command selections to CPU 1201. It should be appreciated that data to and from external devices may be communicated through the input/output device 1209. CPU 1201 can be defined to execute the functionality described herein to enable the functionality described with reference to FIGS. 1-11. The code embodying this functionality may be stored within memory 1203 or mass storage device 1207 for execution by a processor such as CPU 1201 in some embodiments. The operating system on the computing device may be MS-WINDOWS™, OS/2™, UNIX™, LINUX™, iOS™ or other known operating systems. It should be appreciated that the embodiments described herein may also be integrated with a virtualized computing system implemented with physical computing resources.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for spatial alignment of golf-club inertial measurement data and a three-dimensional human skeleton model for golf club swing analysis, comprising:
capturing inertial measurement data of a golf club swing through an inertial measurement unit (IMU); and
sending the inertial measurement data of the golf club swing from the inertial measurement unit to a computing device, so that the computing device determines a three-dimensional trajectory of the golf club swing in a coordinate space of the IMU, determines in human model coordinate space a three-dimensional trajectory of a plurality of human skeleton points in a video of the golf club swing with the video having depth or depth information, determines a transformation matrix from the human model coordinate space to the IMU coordinate space, and calculates an arm-golf club angle that is based on the inertial measurement data of the golf club swing, the transformation matrix, and the three-dimensional trajectory of the plurality of human skeleton points.

2. The method of claim 1, wherein the computing device displays or sends to a mobile device a three-dimensional human skeleton model overlaid onto the video of the golf club swing, and information regarding the arm-golf club angle.

3. The method of claim 1, wherein the computing device calculates an arm-floor angle that is based on the inertial measurement data of the golf club swing, the transformation matrix, and the three-dimensional trajectory of the plurality of human skeleton points.

4. The method of claim 1, wherein the computing device corrects a drifting error of the inertial measurement data of the golf club swing.

5. The method of claim 1, wherein the video having depth or depth information is one of: an RGBD (red, green, blue, depth) video, a video from a video camera with at least one depth sensor, or a video from a stereo camera.

6. The method of claim 1, wherein:
capturing the inertial measurement data of the golf club swing includes capturing impact information; and
the computing device calculates the arm-golf club angle from address to swing end during the golf club swing, including impact.

7. A method for spatial alignment of golf-club inertial measurement data and a three-dimensional human skeleton model for golf club swing analysis, performed by a computing device, comprising:
receiving captured inertial measurement data of a golf club swing from an inertial measurement unit (IMU);
receiving or capturing a video with depth or depth information, of the golf club swing;
determining a three-dimensional trajectory in human model coordinate space of a plurality of human skeleton points, based on detecting and tracking the plurality of human skeleton points in the video with depth or depth information;
determining a three-dimensional trajectory in a coordinate space of the IMU, from the inertial measurement data of the golf club swing;
estimating a transformation matrix from the human model coordinate space to the IMU coordinate space; and
calculating an arm-golf club angle, based on the captured inertial measurement data of the golf club swing, the transformation matrix, and the three-dimensional trajectory of the plurality of human skeleton points.

8. The method of claim 7, further comprising:
calculating an arm-floor angle, based on the captured inertial measurement data of the golf club swing, the transformation matrix, and the three-dimensional trajectory of the plurality of human skeleton points, for at least one frame of the video with depth or depth information.

9. The method of claim 8, wherein calculating the arm-golf club angle comprises:
calculating an angle between a line defined by a hand and a golf club head and a line defined by the hand and an elbow, in human model coordinate space, with coordinates for the hand and the elbow included in the three-dimensional trajectory of the plurality of human skeleton points, and the golf club head coordinates in the human model coordinate space determined based on the three-dimensional trajectory in the IMU coordinate space and the transformation matrix.

10. The method of claim 8, further comprising:
defining a floor plane in human model coordinate space; and
calculating an angle between the defined floor plane and a line defined by a hand and an elbow, based on the three-dimensional trajectory in the human model coordinate space of the plurality of human skeleton points.

11. The method of claim 7, further comprising:
overlaying a three-dimensional human skeleton model sequence of the golf club swing onto the video of the golf club swing, based on the detecting and tracking the plurality of human skeleton points; and
outputting the arm-golf club angle.

12. The method of claim 7, further comprising:
receiving a known distance between a hand and a location of the IMU, relative to a golf club;
extracting a hand trajectory from the trajectory in the human model coordinate space of the plurality of human skeleton points; and
establishing correspondences between the IMU coordinate space and the human model coordinate space, based at least on the known distance between the hand and the location of the IMU and the extracted hand trajectory, wherein the estimating the transformation matrix is based on the established correspondences.

13. The method of claim 7, further comprising:
determining hand positions in the human model coordinate space, based on the detecting and tracking the plurality of human skeleton points in the video with depth or depth information;
determining grip point positions in the IMU coordinate space, based on the inertial measurement data of the golf club swing;
projecting the hand positions from the human model coordinate space into the IMU coordinate space, based on the transformation matrix; and
correcting the transformation matrix and the three-dimensional trajectory in the IMU coordinate space, based on minimizing an error vector associated with the three-dimensional trajectory in the IMU coordinate space.

14. The method of claim 7, further comprising:
detecting a golf club head in the video with depth or depth information;
correcting a golf club head trajectory in the IMU coordinate space, based on the detecting the golf club head; and
correcting the transformation matrix, based on correcting the golf club head trajectory in the IMU coordinate space.

15. A tangible, non-transitory, computer-readable media having instructions thereupon which, when executed by a processor, cause the processor to perform a method comprising:
receiving, from an inertial measurement unit (IMU), inertial measurement data of a golf club swing;
receiving, from at least a camera, a video of the golf club swing, having depth or depth information;
determining, in human model coordinate space, a three-dimensional trajectory of a plurality of human skeleton points, based on detecting and tracking the plurality of human skeleton points in the video with depth or depth information;
determining, in a coordinate space of the IMU, a three-dimensional trajectory of the IMU, based on the inertial measurement data of the golf club swing;
determining a transformation matrix from the human model coordinate space to the IMU coordinate space; and
calculating and outputting an arm-golf club angle, from the captured inertial measurement data of the golf club swing, the transformation matrix, and the three-dimensional trajectory of the plurality of human skeleton points.

16. The computer-readable media of claim 15, wherein calculating the arm-golf club angle comprises:
determining three-dimensional coordinates of a golf club head in the IMU coordinate space, based on the three-dimensional trajectory in the IMU coordinate space;
determining three-dimensional coordinates of the golf club head in human model coordinate space, based on the transformation matrix and the three-dimensional coordinates of the golf club head in the IMU coordinate space; and
determining an angle between a line defined by a hand and the golf club head and a line defined by the hand and an elbow, in the human model coordinate space, based on the determined three-dimensional coordinates of the golf club head in the human model coordinate space and the determined three-dimensional trajectory in the human model coordinate space of the plurality of human skeleton points.

17. The computer-readable media of claim 15, wherein the method further comprises:
determining three-dimensional coordinates of a first foot point and a second foot point in human model coordinate space, from the three-dimensional trajectory in the human model coordinate space of the plurality of human skeleton points;
determining three-dimensional coordinates of a golf club head in the IMU coordinate space, at a time of golf club head impact, based on the three-dimensional trajectory of the IMU, in the IMU coordinate space;
determining three-dimensional coordinates of the golf club head at the time of golf club head impact, in the human model coordinate space, based on the transformation matrix and the three-dimensional coordinates of a golf club in the IMU coordinate space;
defining a floor plane in the human model coordinate space, based on the first foot point, the second foot point and the determined three-dimensional coordinates in the human model coordinate space of the golf club head at the time of golf club head impact; and
determining an angle between the defined floor plane and a line defined by a hand and an elbow, from the three-dimensional trajectory in the human model coordinate space of the plurality of human skeleton points.

18. The computer-readable media of claim 15, wherein the method further comprises:
receiving as user input a known distance between a hand and a location of the IMU, for the golf club swing, wherein the determining the transformation matrix is based on correspondences between the IMU coordinate space in the human model coordinate space with at least one such correspondence based on the known distance between the hand and the location of the IMU.

19. The computer-readable media of claim 15, wherein the method further comprises:
correcting the transformation matrix and the three-dimensional trajectory of the IMU in the IMU coordinate space, based on minimizing an error vector relative to the transformation matrix and the three-dimensional trajectory of the IMU in the IMU coordinate space.

20. The computer-readable media of claim 15, wherein the method further comprises:
determining coordinates in the human model coordinate space of at least two of a left hand, a right hand, a left wrist, and a right wrist, from the three-dimensional trajectory of the plurality of human skeleton points;
determining hand positions based on the coordinates in the human model coordinate space; and
determining a correspondence between the hand positions, in the human model coordinate space, and grip point positions in the IMU coordinate space, wherein determining the transformation matrix is based on the correspondence.
